(19) United States
(12) Patent Application Publication
(10) Pub. No.: US 2010/0024606 A1
(43) Pub. Date: Feb. 4, 2010

(54) EXTENDING LIGHT BULB REPLACING TOOL

(76) Inventor: JOHN BECKER, Laurel, MT (US)

Correspondence Address: James Ray & Associates, 2640 Pitcairn Road, Monroeville, PA, 15146, US

(21) Appl. No.: 12/507,112

(22) Filed: Jul. 22, 2009

Related U.S. Application Data
(60) Provisional application No. 61/084,649, filed on Jul. 30, 2008.

(51) Int. Cl. H01K 3/32

(52) U.S. Cl. 81/53.11

(57) ABSTRACT

An apparatus for changing a light bulb that is out of reach for a person even with the use of a six foot ladder. The apparatus comprises a substantially hollow elongated rod member having a predetermined shape, size and length and formed of a first predetermined material. An extendable member is disposed within the substantially hollow elongated rod member, the extendable member having a second predetermined length and is formed of a second predetermined material. A locking means is engageable with the rod member and the extendable member for adjusting the length of the apparatus. A replaceable vacuum cup having a predetermined shape is disposed on a first end of the extendable member for attachment to such light bulb. A vacuum pump is disposed adjacent a bottom portion of the rod member, such pump is engageable with the cup for creating a vacuum in the cup for securing such light bulb therein. A vacuum release button is disposed on the pump for releasing such vacuum.

### CROSS REFERENCE TO RELATED APPLICATIONS

This application is closely related to and claims benefit from U.S. Provisional Application Ser. No. 61/084,649 filed Jul. 30, 2008.

### FIELD OF THE INVENTION

The present invention relates, in general, to a light bulb replacing tool, and, more particularly, the present invention relates to a light bulb replacing tool that can be used to replace light bulbs in high areas without using a ladder.

### STATEMENT REGARDING FEDERALLY SPONSORED RESEARCH OR DEVELOPMENT

N/A

### BACKGROUND OF THE INVENTION

Many businesses, homeowners and others must hire a professional to change light bulbs on their ceilings. Others that do not wish to pay another person may choose to replace bulbs on their own. This may cause them to drag out bulky ladders. These ladders, quite frequently, are unsafe to use or too heavy for some to carry. In order to reach the light bulbs, one may also have to move furniture, carpeting or other objects that may be in the way.

In other places such a work areas, schools gymnasiums or halls the ceilings may be sufficiently high and may require two employees to set up and move the ladders and scaffolding when changing bulbs. Companies can save money by being able to send only one person to do the job. Having a compact and efficient way to change bulbs may help users to do so, quickly and easily.

### BRIEF SUMMARY OF THE INVENTION

In a first aspect the present invention provides an apparatus for changing a light bulb that is out of reach for a person even with the use of a six foot ladder. The apparatus comprises a substantially hollow elongated rod member having a predetermined shape, a predetermined size and a first predetermined length and formed of a first predetermined material. An extendable member is disposed within the substantially hollow elongated rod member, the extendable member having a second predetermined length and formed of a second predetermined material. A locking means is engageable with the substantially hollow elongated rod member and such extendable member for adjusting the length of the apparatus. A vacuum cup having a predetermined shape is disposed on a first end of the extendable member for attachment to such light bulb. Such vacuum cup is replaceable. A vacuum pump is disposed adjacent a bottom portion of the elongated rod member and is in fluid communication with the vacuum cup for creating a vacuum in the cup for securing such light bulb therein. A vacuum release means is disposed on the pump for releasing the vacuum.

In a second aspect the present invention provides an apparatus for changing a light bulb that is out of reach for a person even with the use of a six foot ladder. Such apparatus comprises a substantially hollow elongated rod member having a predetermined shape, a predetermined size and a first predetermined length and formed of a first predetermined material. An extendable member is disposed within the substantially hollow elongated rod member, such extendable member has a second predetermined length and is formed of a second predetermined material. A locking means engageable with the substantially hollow elongated rod member and with the extendable member for adjusting the length of the apparatus. A suction cup having a predetermined shape is disposed on a first end of the extendable member for attachment to such light bulb. The suction cup is replaceable.

### OBJECTS OF THE INVENTION

It is, therefore, one of the primary objects of the present invention to provide an apparatus for changing light bulbs that are in high places.

Another object of the present invention is to provide an apparatus that includes an extendable member to provide additional height.

Still another object of the present invention is to provide an apparatus that uses a vacuum pump to hold the bulb in place while the old bulb is removed and a new bulb inserted.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE SEVERAL VIEWS OF THE DRAWINGS

FIG. 1 is a front perspective of the apparatus for removing a light bulb according to an embodiment of the invention.

FIG. 2 is a front perspective view of the apparatus shown in FIG. 1 showing two different shapes for the vacuum cup.

FIG. 3 is a side perspective view showing two different pumps.

FIG. 4 is a front perspective view of the apparatus for removing a light bulb according to another embodiment of the invention.

FIG. 5 is a front perspective view of the apparatus shown in FIG. 4 showing different shapes for the suction cup.

### DETAILED DESCRIPTION OF INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for changing a light bulb that is out of reach for a person even with the use of a six foot ladder. The apparatus 10 comprises a substantially hollow elongated rod member 2 having a predetermined size and a first predetermined length and formed of a first predetermined material. An extendable member 4 is disposed within the substantially hollow elongated rod member 2, the extendable member 4 having a second predetermined length and formed of a second predetermined material. A locking means 20 is engageable with the substantially hollow elongated rod member 2 and such extendable member 4 for adjusting the length of the apparatus 10. A vacuum cup 6 having a predetermined shape is disposed on a first end of the extendable member 4 for attachment to such light bulb (not shown). Such vacuum cup 6 is replaceable. A vacuum pump 8 is disposed adjacent a bottom portion of the elongated rod member 2, such vacuum pump 8 is in fluid communication with the vacuum cup 6 for creating a vacuum in the cup 6 for securing such light bulb therein. A vacuum release means 12 is disposed on the pump 8 for releasing the vacuum.

As seen in the drawing Figures such vacuum cup 6 can be made in different shapes to conform to different shaped light bulbs. As stated the vacuum cup 6 is replaceable so the user can put on the cup 6 that corresponds to the shape of the light bulb. In a presently preferred embodiment of the invention such vacuum cup is formed of rubber.

It is also presently preferred that such first predetermined material for forming the elongated rod member 2 is selected from one of aluminum, plastic or fiberglass. It is even more preferred that such material is fiberglass.

It is preferred that such second predetermined material be selected from one of aluminum, plastic and fiberglass, and again even more preferred that such material is fiberglass.

Such first predetermined length of the elongated member is between about 4 and 6 feet and more preferred where the predetermined length is between about 4¾ and about 5¼ feet.

Such second predetermined length is between about 3¾ and about 4¼ feet. Thus, the apparatus 10 can extend from about 5 feet when the extendable member 4 is retracted to about 9 feet when it is fully extended.

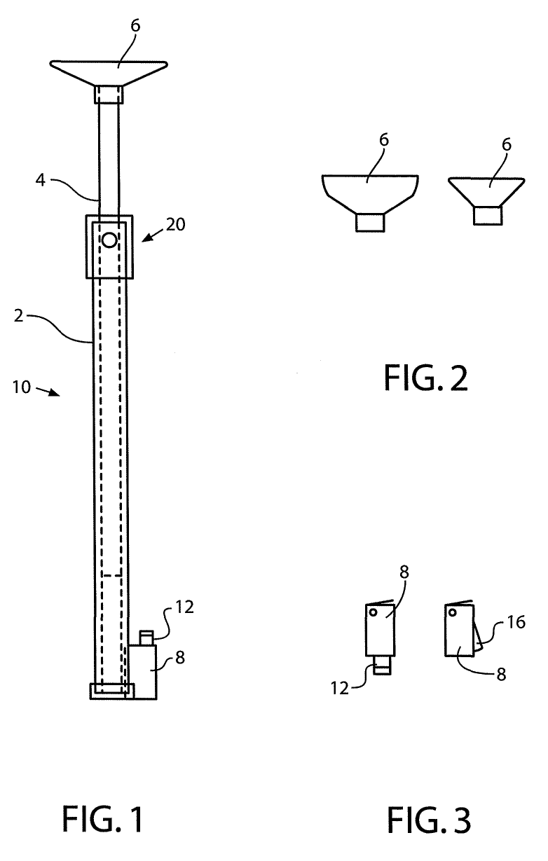

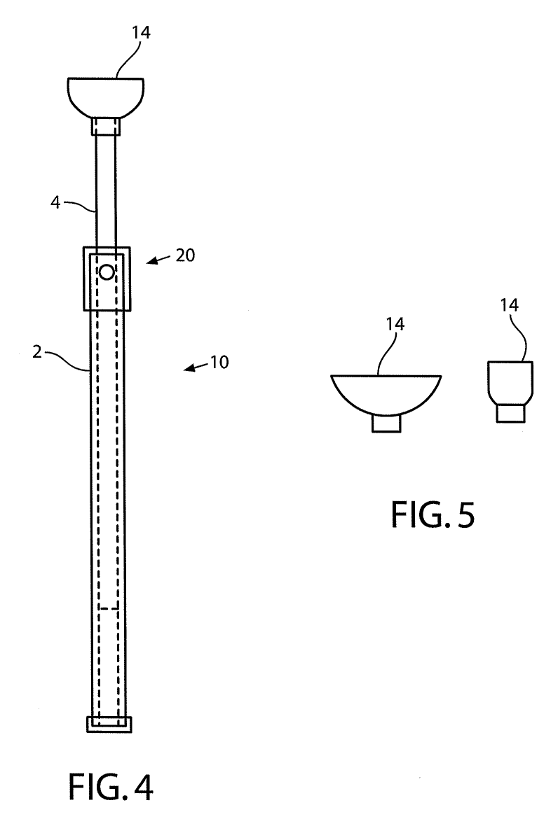

Such vacuum release means 12 for releasing the vacuum is one of a button as seen in FIGS. 1 and 3 and a pistol grip as seen in FIG. 3. In a presently preferred embodiment of the invention such vacuum pump is a hand operated pump 8. Being hand operated provides the advantage electricity is not needed for the operation of the pump.

In a second aspect the present invention provides an apparatus 10 for changing a light bulb that is out of reach for a person even with the use of a six foot ladder. Such apparatus 10 comprises a substantially hollow elongated rod member 2 having a predetermined shape, a predetermined size and a first predetermined length and formed of a first predetermined material. An extendable member 4 is disposed within the substantially hollow elongated rod member 2, such extendable member 4 has a second predetermined length and is formed of a second predetermined material. A locking means 20 is engageable with the substantially hollow elongated rod member 2 and with the extendable member 4 for adjusting the length of the apparatus 10. A suction cup 14 having a predetermined shape is disposed on a first end of the extendable member for attachment to such light bulb. The suction cup 14 is replaceable.

It should be noted that second embodiment of the suction cup attachment can only be used with specific types of light bulbs. It can only be used with light bulbs where the glass is strong as would be the case with bulbs that similar to spot lights or flood lights. It can not be used with a standard light bulb since it is quite possible that the bulb would break when attaching the suction cup.

It is also presently preferred that such first predetermined material for forming the elongated rod member 2 is selected from one of aluminum, plastic or fiberglass. It is even more preferred that such material is fiberglass.

It is preferred that such second predetermined material be selected from one of aluminum, plastic and fiberglass, and again even more preferred that such material is fiberglass.

Such first predetermined length of the elongated member is between about 4 and 6 feet and more preferred where the predetermined length is between about 4¾ and about 5¼ feet.

Such second predetermined length is between about 3¾ and about 4¼ feet.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for changing a light bulb that is out of reach for a person even with the use of a six foot ladder, said apparatus comprising:
(a) an substantially hollow elongated rod member having a predetermined size and a first predetermined length and formed of a first predetermined material;
(b) an extendable member disposed within said substantially hollow elongated rod member, said extendable member having a second predetermined length and formed of a second predetermined material;
(c) a locking means engageable with said substantially hollow elongated rod member and said extendable member for adjusting a length of said apparatus;
(d) a vacuum cup having a predetermined shape disposed on a first end of said extendable member for attachment to such light bulb, said vacuum cup being replaceable;
(e) a vacuum pump disposed adjacent a bottom portion of said elongated rod member and in fluid communication with said vacuum cup for creating a vacuum in said cup for securing such light bulb therein; and
(f) a vacuum release means disposed on said pump for releasing such vacuum.

2. The apparatus, according to claim 1, wherein said first predetermined material is one of aluminum, plastic and fiberglass.

3. The apparatus, according to claim 2, wherein said first predetermined material is fiberglass.

4. The apparatus, according to claim 1, wherein said second predetermined material is one of aluminum, plastic and fiberglass.

5. The apparatus, according to claim 4, wherein said second predetermined material is fiberglass.

6. The apparatus, according to claim 1, wherein said vacuum cup is made of rubber.

7. The apparatus, according to claim 1, wherein said first predetermined length is between about 4 and 6 feet.

8. The apparatus, according to claim 7, wherein said first predetermined length is between about 4¾ and about 5¼ feet.

9. The apparatus, according to claim 1, wherein said second predetermined length is between about 3¾ and about 4¼ feet.

10. The apparatus, according to claim 1, wherein said vacuum release means is a button.

11. The apparatus, according to claim 1, wherein said vacuum release means is a pistol grip.

12. The apparatus, according to claim 1, wherein said vacuum pump is a hand operated pump.

13. An apparatus for changing a light bulb that is out of reach for a person even with the use of a six foot ladder, said apparatus comprising:
(a) an substantially hollow elongated rod member having a predetermined size and a first predetermined length and formed of a first predetermined material;
(b) an extendable member disposed within said substantially hollow elongated rod member, said extendable member having a second predetermined length and formed of a second predetermined material;
(c) a locking means engageable with said substantially hollow elongated rod member and said extendable member for adjusting a length of said apparatus; and
(d) a suction cup member having a predetermined shape disposed on a first end of said extendable member for attachment to such light bulb; said suction cup being replaceable.

14. The apparatus, according to claim 13, wherein said first predetermined length is between about 4 and 6 feet.

15. The apparatus, according to claim 14, wherein said first predetermined length is between about 4¾ and about 5¼ feet.

16. The apparatus, according to claim 15, wherein said second predetermined length is between about 3¾ and about 4¼ feet.

17. The apparatus, according to claim 13, wherein said first predetermined material is one of aluminum, plastic and fiberglass.

18. The apparatus, according to claim 17, wherein said first predetermined material is fiberglass.

19. The apparatus, according to claim 13, wherein said second predetermined material is one of aluminum, plastic and fiberglass.

20. The apparatus, according to claim 19, wherein said second predetermined material is fiberglass.
